(19) United States
(12) Patent Application Publication
(10) Pub. No.: US 2012/0228879 A1
(43) Pub. Date: Sep. 13, 2012

(54) Device for transforming the motion of a water flow into electricity

(76) Inventor: Gianni Bau', Tezze Sul Brenta (VI) (IT)

(21) Appl. No.: 13/509,882

(22) PCT Filed: Nov. 18, 2009
(86) PCT No.: PCT/IB09/55138

§ 371 Date: May 15, 2012

(51) Int. Cl. F03B 7/00

(52) U.S. Cl. 290/54

(57) ABSTRACT

A device for transforming the motion of the flow of a watercourse into a motion for an electricity generator includes one or more circular planes and more than one blade hinged to the circular plane according to a circular arrangement. The blades have two different surfaces arranged on planes that are not parallel to each other, of which a first thrust surface has a surface area that is larger than the surface area of a second lifting surface. The blades are hinged to the circular plane with the same orientation with respect to the center of the circular plane, and the circular plane is designed to be directly or indirectly connected to a rotor of an electricity generator.

### FIELD OF THE INVENTION

The present invention concerns the sector of electric energy generation from renewable sources, and in particular concerns a new device for the production of electric energy through the exploitation of the motion of the flow of a watercourse.

### BACKGROUND OF THE INVENTION

At present the generation of electric energy from renewable sources, for example wind, watercourses, wave motion, tides is a central issue.

Special attention is paid to the mechanisms and systems for the generation of electric energy based on the flow of watercourses.

### SUMMARY OF THE INVENTION

The subject of the present invention is a new device for transforming the motion of the flow of a watercourse, suited to set the rotor of an electricity generator rotating.

One object of the invention is to provide a device that works independently of the direction of the water flow.

Another object of the invention is to provide a device that allows the combination of more than one module for transforming the motion of the water flow into a motion without interference.

The new device for transforming the motion of the flow of a watercourse into a motion suitable for rotating the rotor of an electricity generator comprises, in its main parts, at least one circular plane joined to a cylindrical body, coaxial with said circular plane, and several blades hinged to said circular plane.

The diameter of the cylindrical body is shorter than the diameter of the circular plane and is coaxial with it.

On the side of the cylindrical body that is opposite said circular plane there is a preferably circular closing cover parallel to said circular plane.

A rotation axis is fixed at the centre of said circular plane and rotates in a suitable hole or seat created at the centre of said closing cover.

Said blades are hinged to the annulus included between the outer wall of said cylindrical body and the perimetric edge of said circular plane. In particular, said blades are hinged on the same side of said circular blade to which said cylindrical body is joined.

Said blades are hinged to the surface of the circular plane with the hinge axis substantially radial with respect to said circular plane.

Said blades are made up of two different surfaces, arranged generically orthogonal to each other, which hereinafter will be called thrust surface and lifting surface.

The thrust surface has a substantially rectangular shape, with width equal or inferior to the width of said annulus of the circular plane and height equal or preferably inferior to the height of said cylindrical body. In any case, the height of the thrust surface is such that it does not interfere with the rotation of the blade around its hinge located on the circular plane, and it cannot interfere with the other blades and with any other circular planes used for anchoring other blades onto the same cylindrical body.

The surface area of the lifting surface is smaller than that of the thrust surface, and in particular its width is equal or inferior to the width of said annulus of the circular plane, and its height is inferior to the height of the thrust surface.

The lifting surface of each blade is preferably higher on its side facing the edge of the circular plane and shorter on its side facing the centre of the circular plane, that is, facing the cylindrical body that is integral with said circular plane.

All said blades are hinged to said circular plane on the common corner between the thrust surface and the lifting surface, with the same orientation with respect to a reference direction, clockwise or anticlockwise, on the circular plane. Substantially, all the blades are hinged to the circular plane around the cylindrical body and with the same orientation.

Said blades, made up as described above, are such that when their thrust surface substantially adheres to the surface of the circular plane, their lifting surface is orthogonal to said thrust surface in the same direction as the cylindrical body, and when their thrust surface substantially adheres to the surface of the circular plane their lifting surface is orthogonal to said thrust surface in the same direction as the cylindrical body.

Consequently, the thrust of the water exerted on the thrust surfaces, on one side of the circular plane, is larger than the thrust of the water on the lifting surfaces, on the other side of the circular plane, thus obtaining the rotation of the circular plane.

Inside said cylindrical body there is/are one, two or more shafts parallel to the rotation axis of the circular plane and of the cylindrical body. At least one of said shafts is joined to a wheel, coaxial with the shaft itself and suited to roll on the inner surface of the cylindrical body and to center and balance the cylindrical body and the circular plane with respect to the upper cover.

The rotation axis of the circular plane, extending out of said upper cover of the cylindrical body, can be coupled to the rotor of an electricity generator.

According to the preferred embodiment of the invention, on the inner surface of the cylindrical body, along a circumference that is parallel to and coaxial with the circular plane, coupling teeth are provided that are suited to form an annular gear wheel with toothing facing towards the inside. At least one of said shafts located inside the cylindrical body is provided with a gear wheel suited to be mechanically coupled with the teeth of the gear wheel located inside the cylindrical body.

One of said shafts with gear wheel comes out of said upper cover of the cylindrical body. The upper end of said shaft with gear wheel is suited to be coupled with the rotor of an electricity generator.

The other shafts with gear wheel located inside the cylindrical body serve the function of centering and balancing the cylindrical body and the circular plane with respect to the upper cover.

The operation of the new device is described here below.

The new device is immersed in the watercourse, with the circular plane arranged substantially horizontal and with the axis of said circular plane arranged orthogonal to the direction of the water flow.

The water flow meets and pushes the blades of the new device, and in particular: the blades on one side of the new device with the lifting surface resting on the circular plane and positioned behind the thrust surface with respect to the water flow; the thrust of the water on the thrust surface maintains the lifting surface adherent to the circular plane which in turn maintains said thrust surface orthogonal to the circular plane;

on the other side of the new device the thrust on the thrust surface of the blades is exerted on the same side of the lifting surface of said blades, as a consequence of which said blades rotate on their hinge with the circular plane, until the thrust surface adheres to said circular plane and their lifting surface is orthogonal to the circular plane itself.

Since the lifting surface is smaller than the thrust surface, the blades on one side of the circular plane having the lifting surface orthogonal to the plane itself oppose less resistance to the thurst of water than the blades on the other side of the circular plane having the thrust surface orthogonal to the plane itself. Said difference means that the circular plane rotates in the direction in which the blades with thrust surface orthogonal to the circular plane pass behind the cylindrical body, while the blades with lifting surface orthogonal to the circular plane pass before said cylindrical body.

The blades that pass behind the cylindrical body substantially are not affected by the water flow, since they are covered by the cylindrical body.

The blades that, from behind the cylindrical body, pass beside the cylindrical body, are in a counter current position, and consequently the thrusting force of water makes said blades rotate around their hinge on said circular plane, so that the thrust surface adheres to the surface of the circular plane, while the lifting surface is raised orthogonally to the surface of the circular plane.

As the rotation continues, the lowered blades that from the side of the cylindrical body pass before the cylindrical body, with respect to the direction of the water flow and in the direction against the current, remain in a position with the thrust surface adherent to the circular plane and the lifting surface orthogonal to said circular plane.

As the rotation continues, the blades that from before the cylindrical body pass to the side of the cylindrical body, in the direction following the current, receive a thrust from the water on the side of the lifting surface facing towards the thrust surface. Said thrust of the water in said direction causes the lifting surface to lower towards the circular plane and the thrust surface to be lifted. Following a first initial rotation of said blades, the water of the current exerts its thrust also on the thrust surface, rotating each blade in the position in which the thrust surface is orthogonal to the circular plane and the lifting surface is adherent to the circular plane and behind the thrust surface with respect to the water flow. The blades arranged in this way receive the thrust of the water flow in an asymmetrical way, thus causing the circular plane and the cylindrical body to rotate.

The rotation of the cylindrical body is transmitted from its gear wheel, rack or inner ring to the gear wheels of the shafts housed inside the cylindrical body. At least one of said shafts transmitting motion to the rotor of an electricity generator is in particular positioned eccentrically to the rotation axis of the rotor, with the advantages deriving from said position.

### BRIEF DESCRIPTION OF THE DRAWINGS

The characteristics of the new device for transforming the motion of the flow of a watercourse into a motion suitable for rotating the rotor of an electricity generator will be highlighted in greater detail in the following description with reference to the drawings attached by way of non-limiting example.

FIG. 1 shows a horizontal cross section of a device according to the invention, while FIGS. 2a and 2b show two axonometric views of the new device seen from two different angles.

FIG. 3 shows a detailed view of a blade in a device according to the invention.

FIG. 4 shows a side view of various new devices combined with one another.

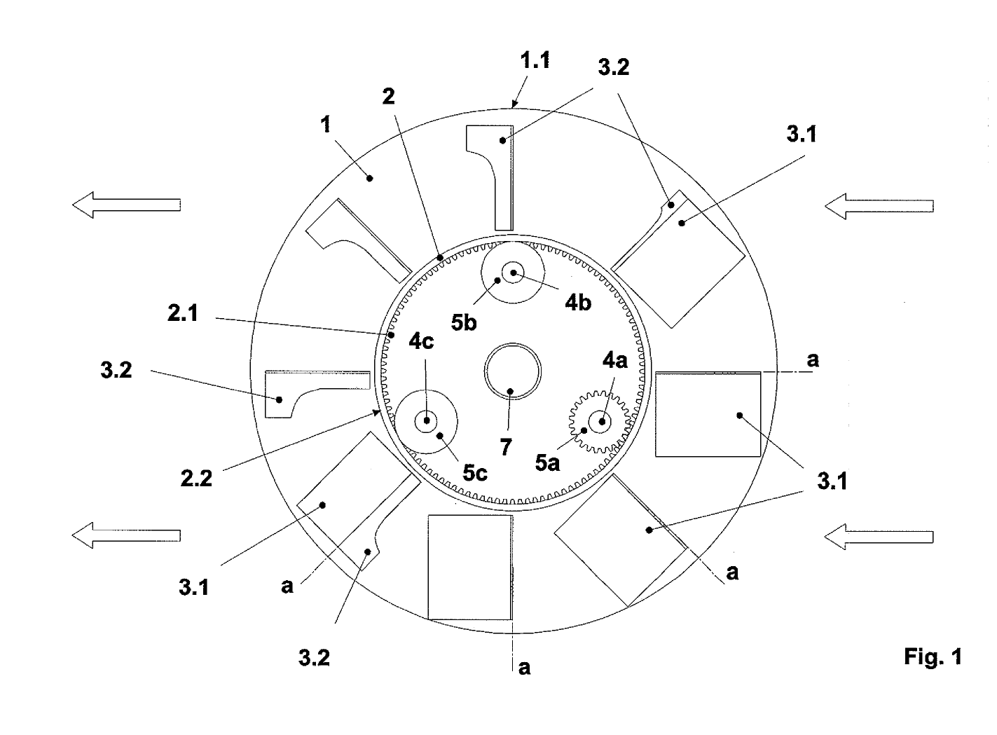

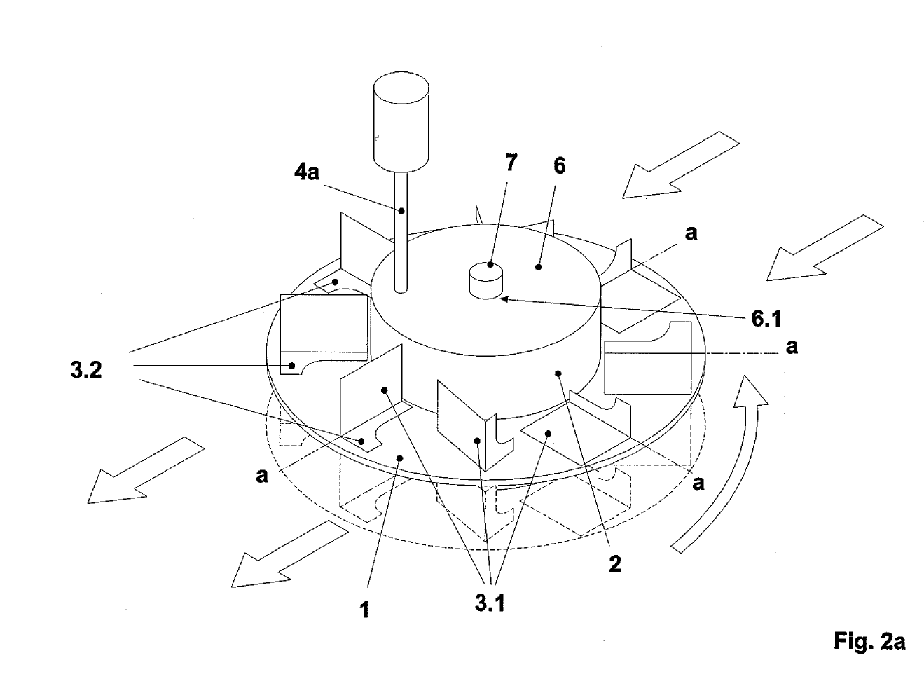

### DETAILED DESCRIPTION OF EMBODIMENTS OF THE INVENTION

The new device for transforming the motion of the flow of a watercourse into a motion suitable for rotating the rotor of an electricity generator comprises, in its main parts, at least one circular plane (1) joined to a cylindrical body (2) coaxial with said circular plane (1), more than one blade (3) hinged to said circular plane (1), several wheels (5a, 5b, 5c), with and without teeth, fixed to rotation shafts (4a, 4b, 4c) and coupled with a rack (2.1) inside said cylindrical body (2) or rolling on the inner surface of said cylindrical body (2).

The cylindrical body (2) has a diameter that is shorter than the diameter of the circular plane (1) and is coaxial with it.

On the side of the cylindrical body (2) that is opposite said circular plane (1) there is a preferably circular closing cover (6) parallel to said circular plane (1). A rotation axis (7) is fixed at the centre of said circular plane (1) and rotates in a suitable hole or seat (6.1) created at the centre of said closing cover (6).

Said blades (3) are hinged to the annulus included between the outer wall (2.2) of said cylindrical body (2) and the perimetric edge (1.1) of said circular plane (1). In particular, said blades (3) are hinged to the same side of said circular plane (1) to which said cylindrical body (2) is joined.

Said blades (3) are hinged to the surface of the circular plane (1) with the hinge axis (a) substantially radial with respect to said circular plane (1).

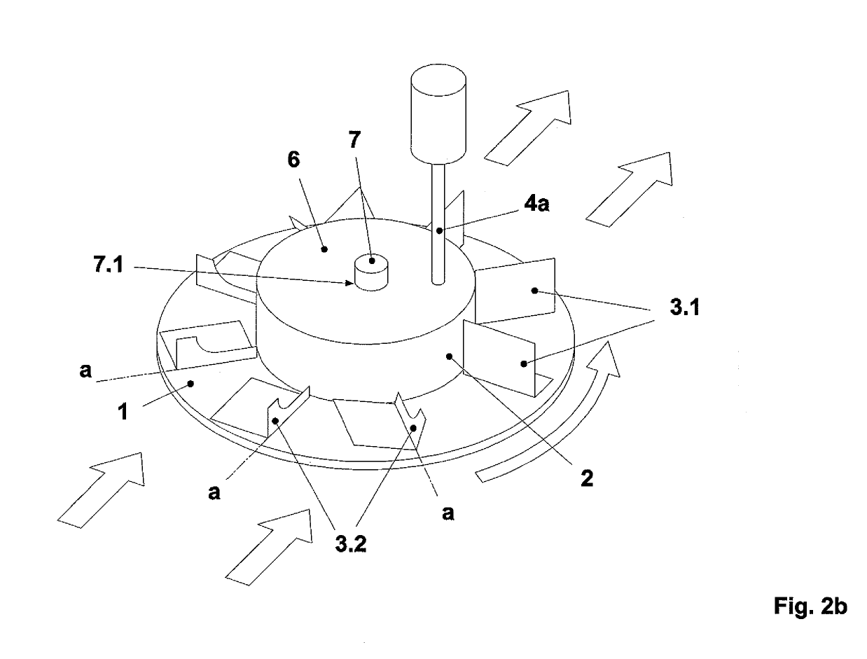

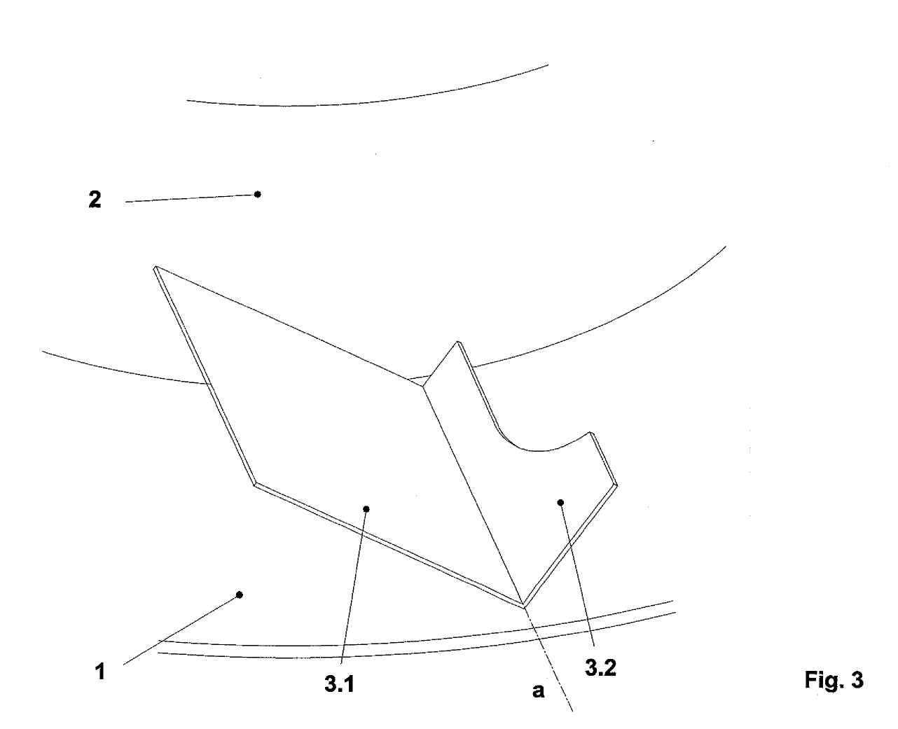

FIG. 3 shows a detailed view of a blade (3) hinged to said circular plane (1).

Said blades (3) comprise two different surfaces (3.1, 3.2), arranged generically orthogonal to each other.

One (3.1) of said surfaces of said blades (3), hereinafter called thrust surface (3.1), is substantially rectangular in shape, with width equal or inferior to the width of said annulus of the circular plane (1), and height equal or preferably inferior to the height of said cylindrical body (2).

The width of the second one (3.2) of said surfaces of said blades (3), hereinafter called lifting surface (3.2), is equal or inferior to the width of said annulus of the circular plane (1), and its height is inferior to the height of the thrust surface (3.1).

The lifting surface (3.2) of each blade (3) is preferably higher on its side facing the edge (1.1) of the circular plane (1) and shorter on its side facing the centre of the circular plane (1), that is, facing the cylindrical body (2) integral with said circular plane (1).

All said blades (3) are hinged to said circular plane (1) with the same orientation with respect to the centre of said circular plane (1).

Said blades (3), made up as described above, are such that when their thrust surface (3.1) substantially adheres to the surface of the circular plane (1), their lifting surface (3.2) is orthogonal to said circular plane (1) in the same direction of the cylindrical body (2), and when their thrust surface (3.1) substantially adheres to the surface of the circular plane (1), their lifting surface (3.2) is orthogonal to said circular plane (1) in the same direction of the cylindrical body On the inner surface of the cylindrical body (2), along a circumference that is parallel to and coaxial with the circular plane (1), coupling teeth are provided that are suited to form a gear wheel (2.1) with toothing facing towards the centre.

Inside said cylindrical body (2) there are two or more shafts (4a, 4b, 4c) parallel to the axis of the circular plane (1) and of the cylindrical body (2). One of said shafts (4a) is joined to a gear wheel (5a), coaxial with the shaft (4a) and suited to be mechanically coupled with the teeth of the gear wheel (2.1) located inside the cylindrical body (2).

Each one of the other shafts (4b, 4c) is joined to a wheel without teeth (5b, 5c) that is suited to roll on the inner surface of said cylindrical body (2).

Said shaft (4a) with gear wheel (5a) comes out of said upper cover (6) of the cylindrical body (2). The upper end of said shaft (4a) with gear wheel (5a) is suited to be coupled with the rotor of an electricity generator.

The other shafts (4b, 4c) with wheel without teeth (5b, 5c) located inside the cylindrical body (2) serve the function of centering and balancing the cylindrical body (2) and the circular plane (1) with respect to the upper cover (6).

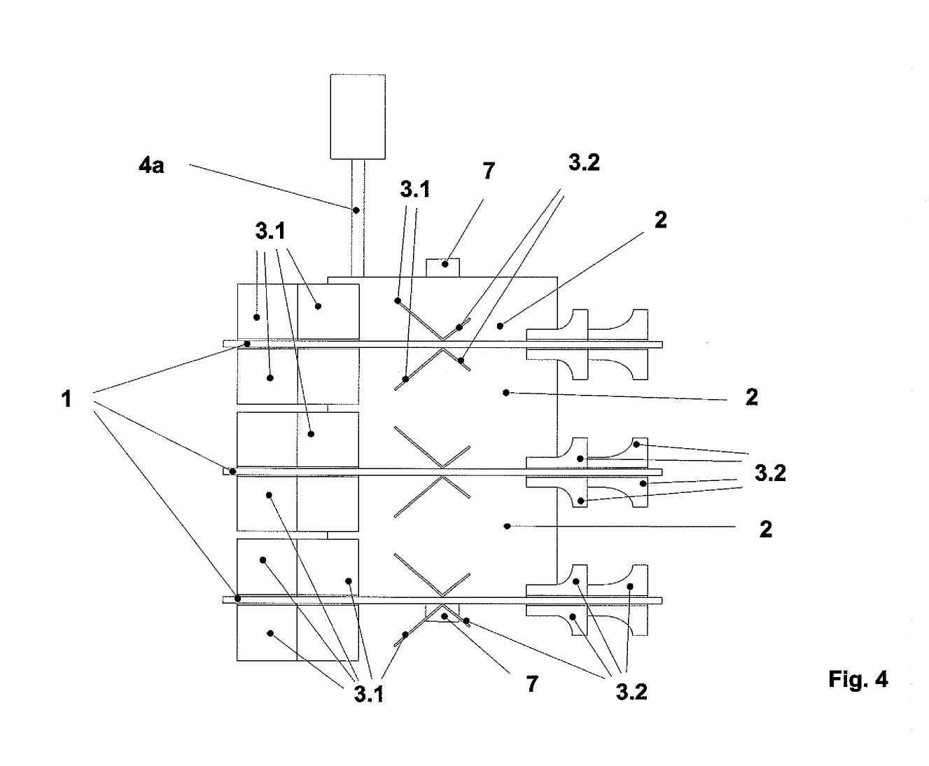

FIG. 4 shows that said blades (3), as described above, can be placed over or under the circular plane (1), in a corresponding or offset position with respect to the blades (3) of the upper and/or lower circular plane (1).

Therefore, with reference to the above description and the attached drawings, the following claims are expressed.

The invention claimed is:

1. A device for transforming a motion of a flow of a watercourse into a motion for an electricity generator,
a circular plane, and
a plurality of blades hinged to said circular plane according to a circular arrangement,
wherein said blades comprise two different surfaces arranged on planes that are not parallel to each other, a first one of the two different surfaces being a first thrust surface has having a surface area that is larger than a second one of the two different surfaces, the second one being a second lifting surface,
wherein said blades are hinged to said circular plane with a same orientation with respect to a center of said circular plane, and
wherein said circular plane is designed to be directly or indirectly connected to a rotor of an electricity generator.

2. The device according to claim 1, further comprising a cylindrical body whose diameter is shorter than a diameter of the circular plane, said cylindrical body being coaxially joined to said circular plane on a same side of the circular plane where said blades are located, wherein said blades are hinged to said circular plane on an annulus included between an outer wall of said cylindrical body and a perimetric edge of said circular plane.

3. The device according to claim 2, wherein the thrust surface of said blades is as wide as or narrower than said annulus of the circular plane, and a height of the thrust surface is equal or preferably inferior to a height of said cylindrical body.

4. The device according to claim 2, wherein the lifting surface of said blades is as wide as or narrower than said annulus of the circular plane, and a height of the lifting surface is inferior to a height of the thrust surface.

5. The device according to claim 1, wherein said blades are positioned either over said circular plane, or under said circular plane, or over and under said circular plane.

6. The device according to claim 4, wherein the lifting surface of said blades is higher on its a side facing the edge of the circular plane and shorter on a side facing the center of the circular plane.

7. The device according to claim 2, wherein an inner surface of said cylindrical body is provided with coupling teeth along a circumference parallel to and coaxial with the circular plane in order to form a gear wheel with teeth facing inwardly, and wherein inside said cylindrical body there is one or more shafts parallel to an axis of the circular plane and of the cylindrical body, at least one of said shafts being provided with a gear wheel coaxial with the shaft, mechanically coupled with said teeth of the gear wheel located inside said cylindrical body.

8. The device according to the claim 7, wherein at least one of said shafts with gear wheel extends from a top of the cylindrical body and has an end that is suited to be coupled with a rotor of an electricity generator.

9. The device according to claim 7, wherein at least one of said shaft with gear wheel, directly or indirectly coupled with a rotor of an electricity generator, is arranged in an eccentric position with respect to a rotation axis of the circular plane.
